(19) United States
(12) Patent Application Publication
(10) Pub. No.: US 2007/0235592 A1
(43) Pub. Date: Oct. 11, 2007

(54) Minimum time or thrust separation trajectory for spacecraft emergency separation

(76) Inventors: Phillippe L. Horn, Long Beach, CA (US); Douglas C. Cameron, Seal Beach, CA (US); Tony A. Lytle, Huntington Beach, CA (US); Eric D. Brown, Huntington Beach, CA (US)

Correspondence Address: GATES & COOPER LLP, HOWARD HUGHES CENTER, 6701 CENTER DRIVE WEST, SUITE 1050, LOS ANGELES, CA, 90045, US

(21) Appl. No.: 11/633,910

(22) Filed: Dec. 5, 2006

Related U.S. Application Data
(60) Provisional application No. 60/742,402, filed on Dec. 5, 2005.

(51) Int. Cl. B64G 1/00

(52) U.S. Cl. 244/158.1

(57) ABSTRACT

A method and apparatus for separating a first spacecraft from a rotating second spacecraft within a separation corridor having a trailing boundary surface is disclosed. The method and apparatus use a non-stationkeeping trajectory that uses a greater portion of the separation corridor to reduce thrust requirements and reduce the time necessary for separation.

### CROSS-REFERENCE TO RELATED APPLICATIONS

This application claims benefit of U.S. Provisional Patent Application No. 60/742,402, entitled “MINIMUM TIME OR THRUST SEPARATION TRAJECTORY (MTTSI) CALCULATION ALGORITHM FOR SPACE TRASPORT VEHICLE EMERGENCY SEPARATION FROM TUMBLING SPACE BASED STRUCTURES,” by Douglas C. Cameron, Philippe L. Horn, Tony A. Lytle, and Eric D. Brown, filed Dec. 5, 2005, which application is hereby incorporated by reference herein.

### BACKGROUND OF THE INVENTION

1. Field of the Invention

The present invention relates to systems and methods for generating separation trajectories, and in particular to a system and method for generating and executing a separation trajectory optimized for minimum separation time or thrust.

2. Description of the Related Art

The design requirements for space transport vehicles such as the Orbital Space Plane (OSP), or the Crew Exploration Vehicle (CEV), generally include the capability to execute emergency separation maneuvers from larger, space-based structures such as the International Space Station (ISS) while this larger structure is tumbling out of control. In order to execute these required on-orbit maneuvers, space transport vehicles use rocket propulsion (thrust-based) maneuvering control systems which guide the vehicle along pre-calculated trajectories that are unique to each maneuver.

The OSP uses a state-of-the-art trajectory calculation algorithm, termed KINSTLER, in order to initiate the guidance for executing the emergency separation maneuver from the ISS. This maneuver is disclosed in U.S. Patent Application Pub. No. 2005/022466A1, which is hereby incorporated by reference herein. However, the KINSTLER maneuver requires use of a heavy and highly complex propulsion maneuvering control system known as a Reaction Control System (RCS)). Two independent sets of thrusters were designed for the RCS to accommodate the guidance maneuvers required by the trajectories calculated using the KINSTLER: (1) a larger thrust primary set and (2) a smaller thrust verruer set. This in turn essentially doubles the weight requirements and system complexity for the RCS design.

What is needed is an apparatus and method for calculating these trajectories in real time in such a way as to optimize (minimize) the time required and/or thrust required to execute the aforementioned on-orbit maneuvers. Minimizing these two parameters allows the design weight and cost of the propulsion maneuvering control system to be minimized. What is also needed is an apparatus and method for minimizing the weight of space transport vehicles. On any flying vehicle, but a space transport vehicle especially, weight is the critical cost design parameter.

The present invention satisfies this need.

### SUMMARY OF THE INVENTION

To address the requirements described above, the present invention discloses a method and apparatus for separating a first spacecraft from a rotating second spacecraft within a separation corridor having a trailing boundary surface is disclosed. The method and apparatus use a non-stationkeeping trajectory that uses a greater portion of the separation corridor to reduce thrust requirements and reduce the time necessary for separation.

In one embodiment, the method comprises the steps of maneuvering the first spacecraft away from the second spacecraft and maneuvering the first spacecraft to exit the separation corridor proximate the trailing boundary surface of the separation corridor. In another embodiment, the spacecraft is maneuvered toward an intermediate location proximate a leading surface of the separation corridor before being maneuvered toward the exit of the separation corridor proximate the trailing surface.

### BRIEF DESCRIPTION OF THE DRAWINGS

FIG. 1 illustrates a simplified diagram of a host spacecraft;

FIG. 2 is a diagram of a representative embodiment of an auxiliary spacecraft;

FIG. 3 is a diagram depicting the functional architecture of a representative attitude control system;

FIG. 4 is a flow chart illustrating exemplary method steps that can be used to implement an improved separation trajectory for minimum thrust, minimum time, or minimum thrust and time trajectories;

FIG. 5 is a diagram showing separation trajectories from a counter-clockwise tumbling host spacecraft;

FIGS. 6A and 6B present flowcharts illustrating an embodiment using a precognitive trajectory that is updated during the separation process;

FIG. 7 diagram of illustrating a trajectory optimized for minimum time rather than minimum thrust; and

FIG. 8 diagram of combination trajectory in which a weighted combination of time and thrust have been minimized.

### DETAILED DESCRIPTION OF PREFERRED EMBODIMENTS

In the following description, reference is made to the accompanying drawings which form a part thereof, and which is shown, by way of illustration, several embodiments of the present invention. It is understood that other embodiments may be utilized and structural changes may be made without departing from the scope of the present invention.

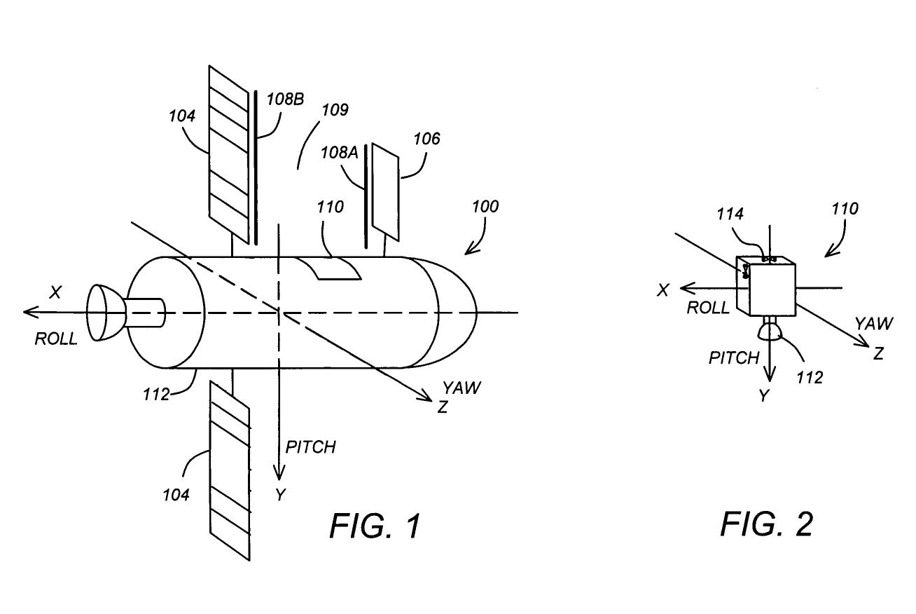

FIG. 1 illustrates a simplified diagram of a spacecraft 100. The spacecraft 100 has a main body 102 and one or more of solar panels 104. The spacecraft 100 may also include a payload or sensor package 106 extending from the main body 102. The sensor package 106 may include sun sensors, earth sensors, and star sensors, as described more fully below.

The three axes of the spacecraft 100 are shown in FIG. 1. The pitch axis P lies along the plane of the solar panels 104. The roll axis R and yaw axis Y are perpendicular to the pitch axis P and lie in the directions and planes as shown.

As described above, the spacecraft 100 may be a large structure such as the international space station (gSS) to which smaller spacecraft such as the orbital space plane (OSP), crew exploration vehicle (CEV) dock to permit the exchange of passengers and/or cargo. The smaller spacecraft may also be an emergency escape pod. Hereinafter, such larger spacecraft 100 may be referred to as “host spacecraft 100,” while the smaller spacecraft may be referred to as “separation spacecraft 110,” or more generally, an “auxiliary spacecraft 110.” The auxiliary spacecraft 110 may also be an ancillary spacecraft that docks and separates from the spacecraft 100 when desired.

In any of these cases, it is important that the separation of one craft from the other be accomplished safely and without undesired contact between the spacecraft. This is relatively simple to accomplish if the host spacecraft 100 is space stabilized in inertial space, but is much more difficult if the host spacecraft 100 is rotating about one or more of its roll, pitch, and yaw axes. To assure that no such undesired contact takes place, the path of the auxiliary spacecraft 110 should remain within the separation corridor 109 defined by the area between interfering host spacecraft 100 structures. For the host spacecraft 100 shown in FIG. 1, for example, the separation corridor 109 for rotations about the yaw axis is defined by boundary surfaces 108A and 108B. Depending on whether the yaw rotation is in the positive or negative direction, separation corridor boundary surface 108A may represent the leading or trailing edge of the corridor 109. In practice, the separation corridor 109 is a volume defined by a number of surfaces. This volume may be without constraint in some directions. For example, in the exemplary spacecraft shown in FIG. 1, if the spacecraft 100 were rolling about the X axis, the separation corridor would extend radially outward away from the X axis.

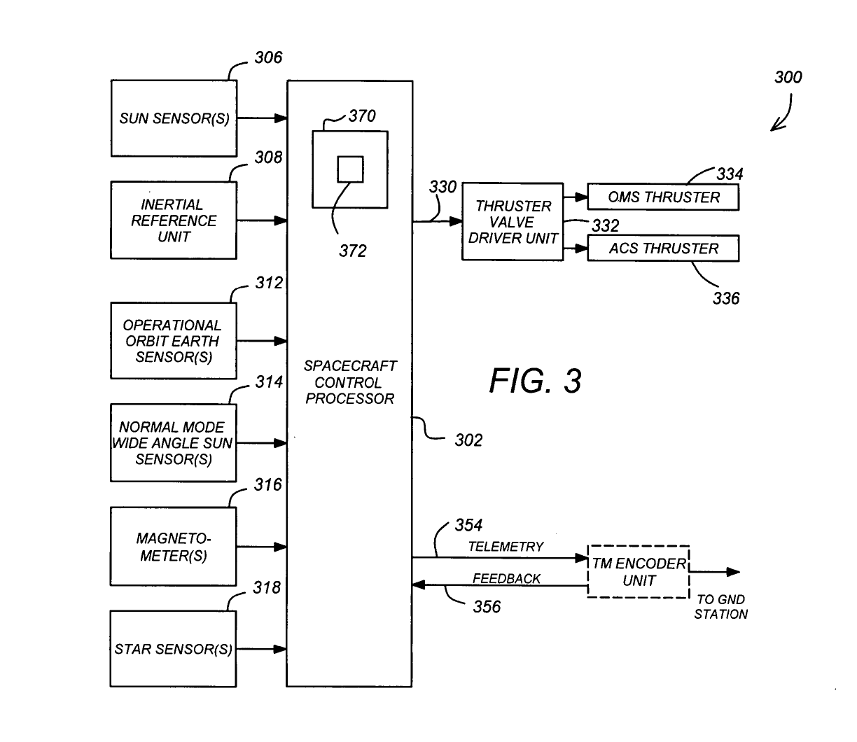

FIG. 2 is a diagram of a representative embodiment of the auxiliary spacecraft 110. The auxiliary spacecraft 100 includes a plurality of attitude control system (ACS) thrusters 114 and an orbital maneuvering system (OMS) thruster 112. The OMS thruster 112 typically provides much greater thrust than the ACS thrusters 114, but in less controllable amounts. In alternate embodiments, the second spacecraft 110 can have no OMS thruster 112, or no ACS thrusters 114 (with thrust direction controlled, for example, by manipulation of the OMS thruster 112 to provide thrust vectors in different directions).

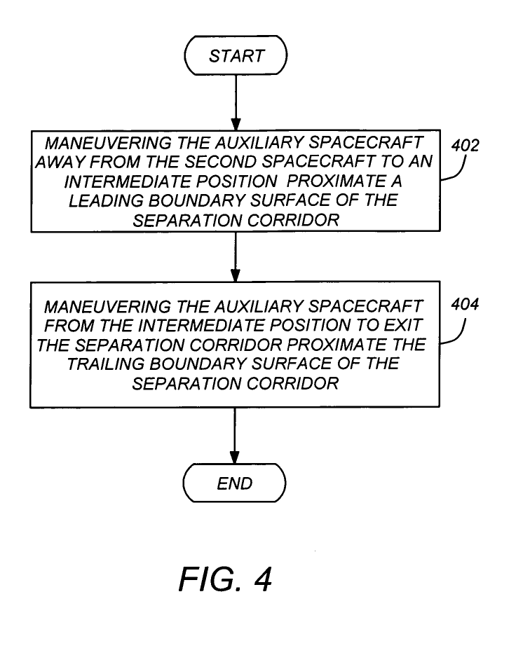

FIG. 3 is a diagram depicting the functional architecture of a representative attitude control system 300. Control of the spacecraft 110 is provided by a computer or spacecraft control processor (SCP) 302. The SCP 302 performs a number of functions which may include post ejection sequencing, orbit processing, acquisition control, station keeping control, normal mode control, mechanisms control, fault protection, and spacecraft systems support, among others.

Input to the SCP 302 may come from a any combination of a number of spacecraft components and subsystems, such as a sun sensor(s) 306, an inertial reference unit 308, Earth orbit sensor(s) 312, normal mode wide angle sun sensor(s) 314, magnetometer(s) 316, and/or one or more star sensors 318.

The SCP 302 also sends control commands 330 to the thruster valve driver unit 332 which in turn controls the OMS thruster 334 and the attitude control thrusters 336.

The SCP 302 can also send command signals 354 to the telemetry encoder unit 358 which in turn sends feedback and/or command signals 356 to the SCP 302. This feedback loop, as with the other feedback loops to the SCP 302 described earlier, assist in the overall control of the spacecraft 110. The SCP 302 communicates with the telemetry encoder unit 358, which receives the signals from various spacecraft components and subsystems indicating current operating conditions, and then relays them to the ground station 260 or the spacecraft 100.

Internal torquers such as reaction wheels may also be used to assist in the attitude control of the spacecraft 110.

The SCP 302 may include or have access to memory 370, such as a random access memory (RAM). Generally, the SCP 302 operates under control of an operating system 372 stored in the memory 370, and interfaces with the other system components to accept inputs and generate outputs, including commands. Applications running in the SCP 302 access and manipulate data stored in the memory 370. The spacecraft 110 may also comprise an external communication device such as a satellite link for communicating with other computers at, for example, a ground station. If necessary, operation instructions for new applications can be uploaded from ground stations.

In one embodiment, instructions implementing the operating system 372, application programs, and other modules are tangibly embodied in a computer-readable medium, e.g., data storage device, which could include a RAM, EEPROM, or other memory device. Further, the operating system 372 and the computer program are comprised of instructions which, when read and executed by the SCP 302, causes the spacecraft processor 302 to perform the steps necessary to implement and/or use the present invention. Computer program and/or operating instructions may also be tangibly embodied in memory 370 and/or data communications devices (e.g. other devices in the spacecraft 10 or on the ground), thereby making a computer program product or article of manufacture according to the invention. As such, the terms “program storage device,” “article of manufacture” and “computer program product” as used herein are intended to encompass a computer program accessible from any computer readable device or media.

To reduce the system weight and complexity described above, the present invention describes an emergency separation maneuver that decreases the number of thrusters while simultaneously increasing the robustness of the design to execute previously overlooked maneuver complications, such as a “dog leg” (a bend in the exit path).

The present invention can be implemented in a number of ways. It can be used to generate a separation trajectory that requires minimum thrust (and hence, minimum cost) or can be used to generate a separation trajectory that minimizes separation time (at which the second spacecraft 110 is no longer in any danger of contacting the first spacecraft 100). Trajectories can be defined that are not minimal thrust or minimal time, but rather balance the concerns of both to meet a wide range of system requirements.

All of the above trajectories are significant modifications to the original KINSTLER trajectories described in U.S. Pat. No. 7,114,684 (hereby incorporated by reference herein), and a combination of the two results in a substantial improvement to the design of the RCS. This combination, termed the Minimum Time or Thrust Separation Trajectory (MTTST) algorithm, reduces thruster requirements by a factor of about four. The reduced thrust requirement eliminates the need for the primary set of thrusters dedicated to the purpose of emergency separation, thereby simplifying the RCS to one set of vernier thrusters that would ordinarily be used for attitude control. This decreases vehicle weight, part count, and cost by nearly a factor of 2.0.

MTTST also increases the robustness of the calculated trajectory which allows for better compensation for uncertainties, such as radical changes to the ISS tumble dynamics during the separation maneuver.

While the KINSTLER separation trajectory algorithm provides a workable method for successful separation of one spacecraft 110 from another tumbling spacecraft 100, the MTTST separation trajectory algorithm provides all the same functionality, but with significantly increased robustness, reduced thruster size/quantity, and an added capability for manual piloting.

This is accomplished by taking advantage of the full volume of the separation corridor 109 in determining the best trajectory from the feasible separation trajectories. For the minimum time, minimum thrust, and combined trajectories, this is accomplished maneuvering the first spacecraft to exit the separation corridor proximate the trailing boundary surface of the separation corridor.

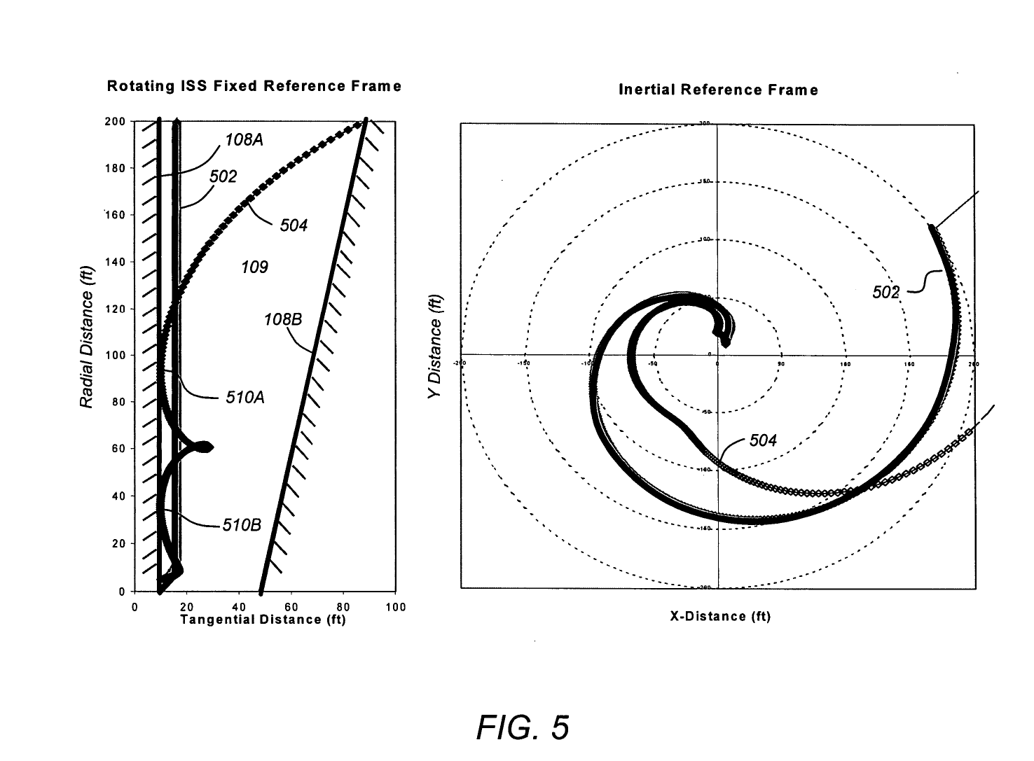

FIG. 4 is a flow chart illustrating exemplary method steps that can be used to implement an improved separation trajectory for minimum thrust or combined (minimizing both thrust and time) trajectories. First, as shown in block 402, the auxiliary spacecraft 110 is maneuvered away from the host spacecraft 100 to an intermediate position proximate (but not intersecting) the leading boundary surface 108 of the separation corridor 109. For example, if the host spacecraft 100 in FIG. 1 were rolling in the negative direction about the yaw axis (with direction determined by the right hand rule), the leading boundary surface of the separation corridor 109 is surface 108A. Next, as shown in block 404, the auxiliary spacecraft 110 is maneuvered away from the intermediate position and the leading boundary surface 108 of the separation corridor 109 and toward a trailing boundary surface (in the above example, surface 108B) of the separation corridor 109.

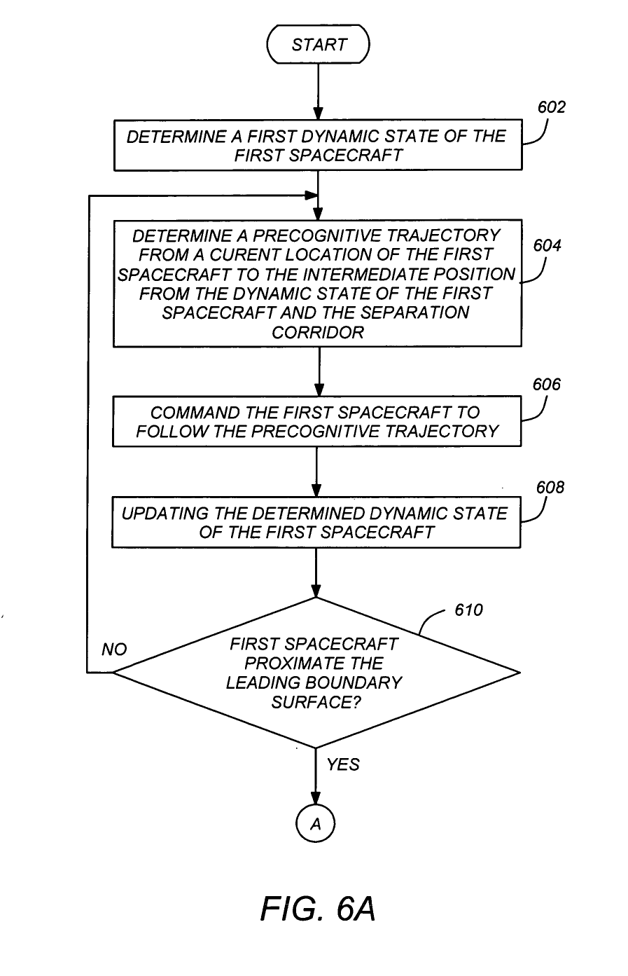

FIG. 5 is a diagram showing separation trajectories from a counter-clockwise tumbling host spacecraft 100. The leftmost plot shows the position of the auxiliary spacecraft 110 plotted in the reference frame of the host spacecraft 100 that the auxiliary spacecraft 110 is separated from, expressed in terms of its radial distance between the host and auxiliary spacecraft 100, 110 in the direction of interest versus and its tangential distance from the separation point (the reference frames rotate with the host spacecraft 100). For example, if the host spacecraft 100 shown in FIG. 1 were rotating in the yaw direction in with a negative direction (clockwise from the perspective shown in FIG. 1), the radial distance is in the −Y direction and the tangential distance is in the −X direction. The separation corridor 109 is indicated as the area inside the leading 108A and trailing 108B boundary surfaces.

Note that the Kinstler trajectory 502 leaves the host spacecraft 100 and then proceeds along a straight path at a constant distance from the leading boundary surface 108A or the separation corridor 109. The majority of thrust continuously turns the inertial spacecraft velocity vector in order to provide tangential station keeping. Tangential station keeping involves applying the correct thrust so that the spacecraft separates at a constant velocity while remaining in the center of the exit envelope (like moving along the spoke of a turning wheel). The majority of thrust is directed towards the center of rotation, in the opposite direction of the separation trajectory. In other words, the inward thrust direction slows the radial separation from the center of rotation.

A second, non-tangential trajectory 504 is also plotted. This trajectory 504 minimizes thrust by exiting the separation corridor 109 proximate the trailing boundary surface 108B of the exit corridor 109. The trajectory 504 can be further optimized to reduce thrust requirements to a minimum by selecting the trajectory such that it is proximate the leading boundary surface 108A at one or more locations (hereinafter referred to as “intermediate locations” 510A and 510B) before heading to the trailing boundary surface 108B of the separation corridor 109. The rightmost plot illustrates the same information, but as expressed in an inertial reference frame.

During the early phase of the maneuver, the spacecraft 110 maneuvers to the leading boundary surface 108A of the separation corridor 109. It tracks closely to the leading boundary surface 108A until it reaches one of the intermediate locations where it either thrusts or drifts to the trailing boundary surface 108B. The minimum thrust trajectory 504 can be implemented with thrusters that are ordinarily used for attitude control. The initial thrust direction turns the velocity vector of the auxiliary spacecraft 110 towards the leading boundary surface 108A, and a second thrust stage slings the spacecraft 110 to higher radial velocities in the anticipated direction of the trailing edge 108B of the separation corridor 109 in approximately ¾ of a full revolution. Computing this arc to fit within the spatial constraint of the separation corridor is akin to a rifleman leading a moving target with an extra constraint. Using trajectories optimized for minimum thrust, it is possible to decrease thrust requirements by a factor of about four.

The foregoing techniques may also be applied to optimize trajectories for systems that combine the attitude control thrusters 114 and with the OMS thruster 112 in order to provide greater robustness to failures, as well as adding a capability for manual piloting. The OSP, for example, has sufficient thrust from the ACS thrusters 114 alone to execute separation trajectories that remain within a tightly bounded separation corridor provided that the maneuvers be flown by automated, closed-loop guidance and flight controls. However, the foregoing techniques enables a flight crew to manually fly the separation maneuver by combining the thrust of the ACS thrusters 114 with the OMS thruster 112. Note that each of the OSP's OMS thrusters provides 870 lbf, which is just a fraction of the 6,000 lbf thrust per engine for the Space Shuttle's OMS thrusters.

The maneuvers described herein are performed according to a trajectories that are computed in real time upon separation using the inertial state (position, rotation rate, and optionally, acceleration) of the auxiliary spacecraft 110. Alternatively, the trajectories can be precognitive . . . that is, precomputed before separation, and applied at the appropriate time. Such precognitive trajectories can be fire and forget (e.g. loaded before separation and not altered thereafter) or periodically updated and recomputed, based on measurements of the inertial state of the auxiliary spacecraft 110. Further, the computation of the trajectories meeting the requirements outlined above can be accomplished using well known techniques, including those disclosed in U.S. Pat. No. 7,114,684.

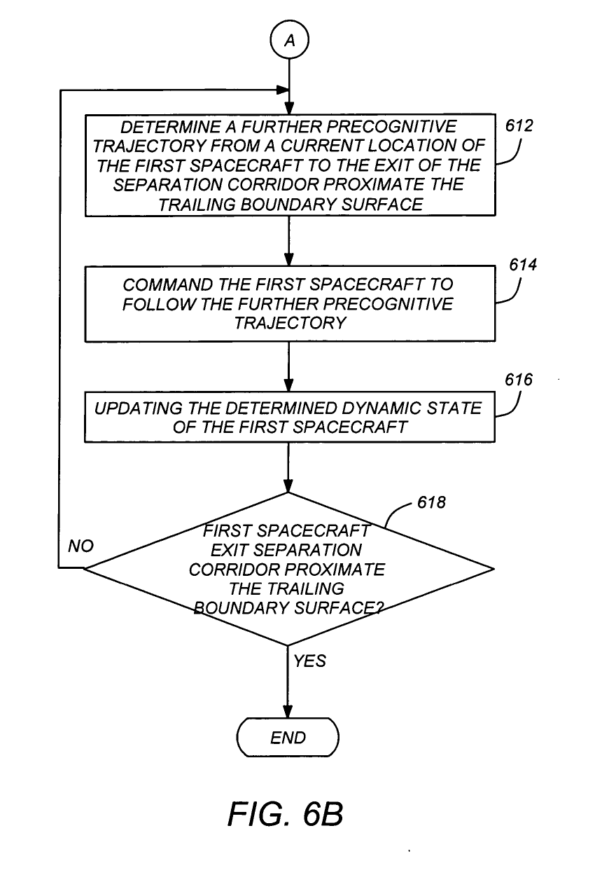

FIGS. 6A and 6B present flowcharts illustrating an embodiment using a precognitive trajectory that is updated during the separation process. In block 602, a first dynamic state (including the position, angular rates, and optionally, accelerations) of the spacecraft 110 of the first spacecraft is determined. This information can be determined from the sensors 306-318 shown in FIG. 3, or can be downloaded from the spacecraft 100 being separated from. A precognitive trajectory to an intermediate position is determined from the determined dynamic state and the separation corridor 109, as shown in block 604. The spacecraft is then commanded to follow that trajectory, using a suitable thruster command profile applied to thrusters 114 and/or 112. This is shown in block 606 the dynamic state of the spacecraft 110 is then updated, preferably by the SCP 302 based on measurements from instruments 306-318. The updated dynamic state is compared to the desired state to determine if the spacecraft 110 is on the proper trajectory. If the spacecraft 110 is on the proper trajectory, no spacecraft continues to be provided with the same thruster command profile. If the spacecraft 110 is not, the precognitive trajectory is either updated or a new precognitive trajectory is computed based upon the separation corridor 109 and the updated dynamic state information. This continues until the spacecraft is proximate the leading boundary surface 108A. These operations are disclosed in blocks 608 and 610.

The process is further illustrated in FIG. 6B, which illustrates the determination of a further precognitive trajectory, computed from the current location of the first spacecraft to the exit of the separation corridor proximate the trailing boundary surface 108B of the separation corridor 109. This is shown in block 612. The spacecraft 110 is then commanded to follow the further precognitive trajectory, as shown in block 616. The determined dynamic state of the spacecraft 110 is updated as before, and used to compare the actual trajectory with the precognitive trajectory to determine of course corrections are required. If corrections are required, a further precognitive trajectory is computed using the current dynamic state and location, as well as the separation corridor. This technique of recomputing the trajectory in real time permits the separation trajectory to respond to a changing separation corridor (due perhaps, to structural failures in the mother spacecraft 100).

Of course, the precognitive and further precognitive trajectories can both be predetermined before separation. As described above, it is not necessary to determine a trajectory to an intermediate position and a further trajectory to an exit location. It is also envisioned that in many cases, a single trajectory will be determined. This would be the case, for example, where a minimum time trajectory was desired.

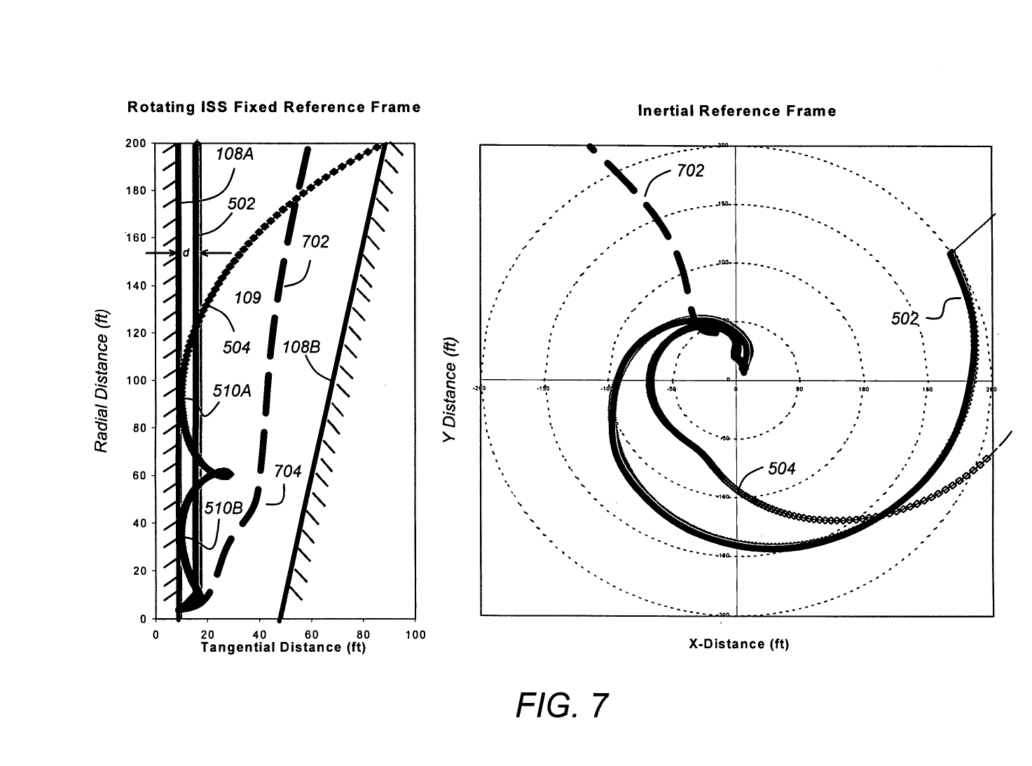

FIG. 7 diagram of illustrating a trajectory optimized for minimum time rather than minimum thrust. Note that the Kinstler trajectory 502 moves a distance from the leading boundary surface 108A and then remains a constant distance d from the leading boundary surface 108A until the spacecraft 110 exits the separation corridor 109. In contrast, the minimum time trajectory 702 separates further from the leading boundary surface 108A at a slower rate, thus approaching the trailing boundary surface 108B, and includes a location 704 at which the spacecraft 110 performs a further maneuver to exit the separation corridor 109 proximate the trailing boundary surface 108A.

Note that if one were to consider the differential of the distance between the trajectory and the leading boundary surface 108A of the Kinstler trajectory 502, the result would be a pulse at the beginning of the trajectory, and zero thereafter (since the distance between the trajectory and the leading boundary surface 108A thereafter remains constant). In contrast, the differential of the distance between the minimum thrust trajectory 504 and the leading boundary surface 108A starts with a positive pulse, then turns negative (as the trajectory approaches the leading boundary surface 108A), turns positive (as the trajectory 504 leaves the leading boundary surface 108A), again turns negative (as the trajectory 504 again approaches the leading boundary surface 108A), and then finally turns positive (as the trajectory 504 leaves the leading boundary surface 108A and heads toward the trailing boundary surface 108B at the exit of the separation corridor 109. The differential of the distance between the leading boundary surface 108A and the minimum time trajectory is characterized by a smaller pulse. The differential remains positive (since the trajectory 702 continues to separate from the leading boundary surface 108A at all times) but at different rates.

The minimum time trajectory 702 can be performed manually or automatically. While the auxiliary spacecraft 110 is close to the center of rotation, the ACS thrusters 114 provide the translational acceleration that moves the auxiliary spacecraft 110 far enough away from the center of rotation of the host spacecraft 100 in order to ignite the OMS thruster(s) 112 without damage to the host spacecraft 100 structure and appendages. The ACS thrusters 114 then rotate the auxiliary spacecraft 110 and point the OMS thruster(s) 112 towards the center of rotation. When the OMS thruster 112 is ignited, the pointing accuracy requirement is such that the flight crew may manually point the auxiliary spacecraft 110 without sophisticated situational awareness instrumentation. The larger thrust-to-weight ratio of the OMS thruster(s) 112 provide enough maneuvering capability to correct for large trajectory dispersions.

The foregoing techniques can be used to arrive at a trajectory that optimizes a weighted combination of minimum time and minimum thrust. The result is a trajectory that is neither minimum time nor minimum thrust, but provides substantially reduced separation times with substantially reduced thrust requirements.

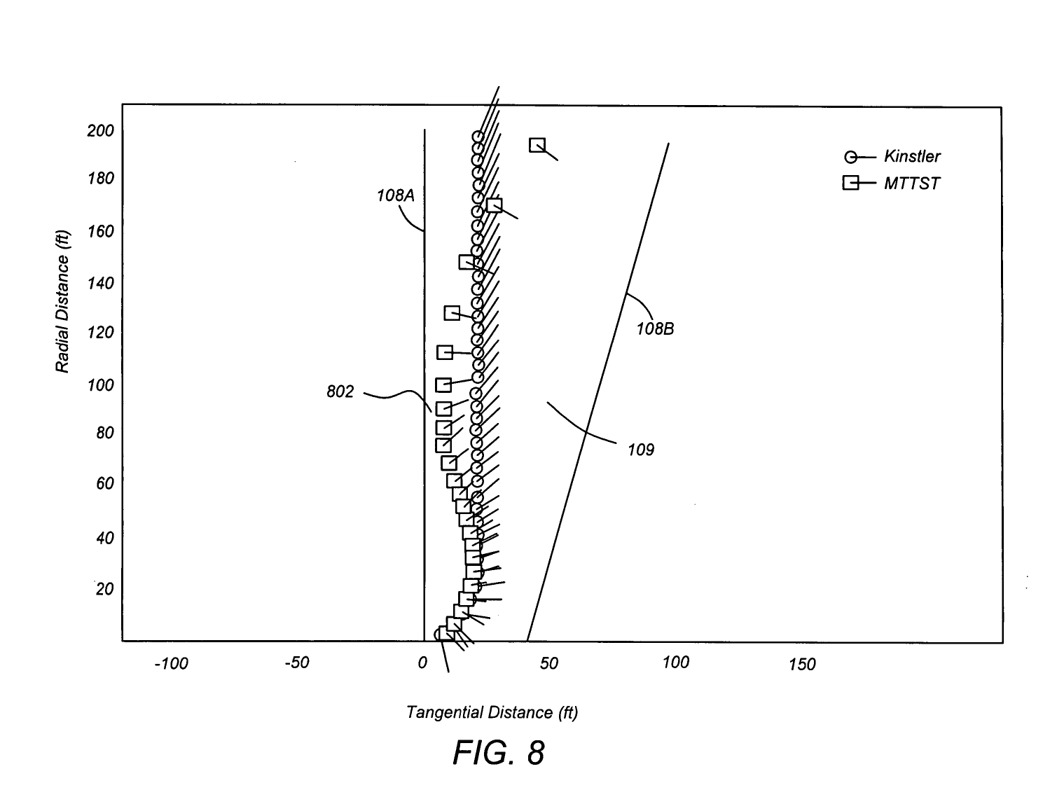

FIG. 8 diagram of combination trajectory in which a weighted combination of time and thrust have been minimized. The diagram includes both the position of the auxiliary spacecraft 110 during the separation maneuver and the thrust magnitude and direction, with each tick mark representing a 5 second increment. The position of the auxiliary spacecraft 110 is indicated by a small circle (using the Kinstler trajectory) and a small square (using the minimum thrust and time trajectory), while the relative thrust magnitude and direction is indicated by the line segments leaving the circle and square (the thrust direction is indicated by the vector from the tail of the line segment to the circle or square). In the trajectory shown in FIG. 8, thrust is used to steer the auxiliary spacecraft 110 to an intermediate position 802 that is proximate the leading boundary surface 108A (and approximately 90 feet from the center of the rotation of the mother spacecraft 100), and thereafter, steered to exit the separation corridor 109 proximate the trailing boundary surface 108B. Note that the MTTST trajectory exits the separation corridor 109 quickly, and performs this feat with a maximum acceleration of 0.13 g. Conversely, the Kinstler trajectory requires greater acceleration (0.25 g) and hence larger thrusters, yet takes additional time to exit the separation corridor 109.

The MTTST trajectory can reduce the required thrust magnitude for each thruster from 100 lbf to 25 lbf, which allows for the elimination of the primary thruster system in the ACS. In addition to reducing the thrust requirements, the MTTST trajectories also substantially reduce the exit time during an emergency separation maneuver—in some cases, from 197 seconds down to 57 seconds. This translates into increased safety in the event of an emergency separation. Also, in the event of a double failure in the OSP's OMS, the MTTST allows the ACS to back-up the OMS, creating additional safety enhancement in the overall design of the OSP.

In summary, the MTTST or modified KINSTLER emergency separation trajectory results in a significant improvement in design weight, cost, system complexity, safety, and functionality relative to those generated using the KINSTLER method.

The foregoing descriptions of the preferred embodiments of the invention have been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto. The above specification, examples and data provide a complete description of the manufacture and use of the composition of the invention. Since many embodiments of the invention can be made without departing from the spirit and scope of the invention, the invention resides in the claims hereinafter appended.

What is claimed is:

1. A method of separating a first spacecraft from a rotating second spacecraft within a separation corridor having a trailing boundary surface, comprising the steps of:
maneuvering the first spacecraft away from the second spacecraft; and
maneuvering the first spacecraft to exit the separation corridor proximate the trailing boundary surface of the separation corridor.

2. The method of claim 1, wherein the separation corridor further comprises a leading boundary surface, and wherein:
the step of maneuvering the spacecraft away from the second spacecraft comprises the step of maneuvering the first spacecraft to an intermediate position proximate a leading boundary surface of the separation corridor; and
the step of maneuvering the first spacecraft to exit the separation corridor proximate the trailing boundary surface of the separation corridor comprises the step of maneuvering the first spacecraft from the intermediate position to exit the separation corridor proximate the trailing boundary surface of the separation corridor

3. The method of claim 2, wherein the step of maneuvering the first spacecraft proximate a leading boundary surface of the separation corridor comprises the steps of:
(a) determining a first dynamic state of the first spacecraft;
(b) determining a precognitive trajectory from a current location of the first spacecraft to the intermediate position from the dynamic state of the first spacecraft and the separation corridor;
(c) commanding the first spacecraft to follow the precognitive trajectory;
(d) updating the determined dynamic state of the first spacecraft; and
(e) repeating steps (b)-(f) until the first spacecraft is proximate the leading boundary surface of the separation corridor.

4. The method of claim 3, wherein the step of maneuvering the first spacecraft away from the second spacecraft to exit the separation corridor toward a trailing boundary surface of the separation corridor comprises the steps of:
(f) determining a further precognitive trajectory from a current location of the first spacecraft to the exit of the separation corridor proximate the trailing boundary surface;
(g) commanding the first spacecraft to follow the further precognitive trajectory;
(h) updating the determined dynamic state of the first spacecraft; and
(i) repeating steps (f)-(h) until the first spacecraft has exited the separation corridor proximate the trailing boundary surface.

5. The method of claim 2, wherein the first spacecraft comprises attitude control thrusters, and the attitude control thrusters are activated to maneuver the first spacecraft proximate a leading boundary surface of the separation corridor.

6. The method of claim 2, wherein the first spacecraft comprises attitude control thrusters, and the attitude control thrusters are activated to maneuver the first spacecraft away from the second spacecraft to exit the separation corridor toward a trailing boundary surface of the separation corridor.

7. The method of claim 2, wherein:
the first spacecraft comprises attitude control thrusters and orbital maneuvering system (OMS) thrusters, and
the step of commanding the first spacecraft to follow the precognitive trajectory comprises the step of:
commanding the attitude control thrusters to orient the first spacecraft; and
commanding the OMS thrusters to displace the first spacecraft.

8. The method of claim 2, wherein the first spacecraft exits the separation corridor within approximately ¾ of a rotation of the rotating second spacecraft.

9. The method of claim 2, wherein the first spacecraft is maneuvered toward a point on the leading surface of the separation corridor approximately 90 feet from the second spacecraft.

10. An apparatus for separating a first spacecraft from a rotating second spacecraft within a separation corridor having a trailing boundary surface, comprising:
a spacecraft control processor, having a memory storing instructions for
maneuvering the first spacecraft away from the second spacecraft; and
maneuvering the first spacecraft to exit the separation corridor proximate the trailing boundary surface of the separation corridor.

11. The apparatus of claim 10, wherein the separation corridor further comprises a leading boundary surface, and wherein:
the instructions for maneuvering the spacecraft away from the second spacecraft comprise instructions for maneuvering the first spacecraft to an intermediate position proximate a leading boundary surface of the separation corridor; and
the instructions for maneuvering the first spacecraft to exit the separation corridor proximate the trailing boundary surface of the separation corridor comprise instructions for maneuvering the first spacecraft from the intermediate position to exit the separation corridor proximate the trailing boundary surface of the separation corridor

12. The apparatus of claim 11, wherein the instructions for maneuvering the first spacecraft proximate a leading boundary surface of the separation corridor comprise instructions for:
(a) determining a first dynamic state of the first spacecraft;
(b) determining a precognitive trajectory from a current location of the first spacecraft to the intermediate position from the dynamic state of the first spacecraft and the separation corridor;
(c) commanding the first spacecraft to follow the precognitive trajectory;
(d) updating the determined dynamic state of the first spacecraft; and
(e) repeating steps (b)-(f) until the first spacecraft is proximate the leading boundary surface of the separation corridor.

13. The apparatus of claim 11, wherein the instructions for maneuvering the first spacecraft away from the second spacecraft to exit the separation corridor toward a trailing boundary surface of the separation corridor comprise instructions for:
(f) determining a further precognitive trajectory from a current location of the first spacecraft to the exit of the separation corridor proximate the trailing boundary surface;
(g) commanding the first spacecraft to follow the further precognitive trajectory;
(h) updating the determined dynamic state of the first spacecraft; and
(i) repeating steps (f)-(h) until the first spacecraft has exited the separation corridor proximate the trailing boundary surface.

14. The apparatus of claim 11, wherein the first spacecraft comprises attitude control thrusters, and the attitude control thrusters are activated to maneuver the first spacecraft proximate a leading boundary surface of the separation corridor.

15. The apparatus of claim 11, wherein the first spacecraft comprises attitude control thrusters, and the attitude control thrusters are activated to maneuver the first spacecraft away from the second spacecraft to exit the separation corridor toward a trailing boundary surface of the separation corridor.

16. The apparatus of claim 11, wherein:
the first spacecraft comprises attitude control thrusters and orbital maneuvering system (OMS) thrusters, and
the instructions for commanding the first spacecraft to follow the precognitive trajectory comprise instructions for:
commanding the attitude control thrusters to orient the first spacecraft; and
commanding the OMS thrusters to displace the first spacecraft.

17. The apparatus of claim 11, wherein the first spacecraft exits the separation corridor within approximately ¾ of a rotation of the rotating second spacecraft.

18. The apparatus of claim 11, wherein the first spacecraft is maneuvered toward a point on the leading surface of the separation corridor approximately 90 feet from the second spacecraft.

19. An apparatus for separating a first spacecraft from a rotating second spacecraft within a separation corridor having a trailing boundary surface, comprising:
means for maneuvering the first spacecraft away from the second spacecraft; and
means for maneuvering the first spacecraft to exit the separation corridor proximate the trailing boundary surface of the separation corridor.

20. The apparatus of claim 19, wherein the separation corridor further comprises a leading boundary surface, and wherein:
the means for maneuvering the spacecraft away from the second spacecraft comprises means for maneuvering the first spacecraft to an intermediate position proximate a leading boundary surface of the separation corridor; and
the means for maneuvering the first spacecraft to exit the separation corridor proximate the trailing boundary surface of the separation corridor comprises means for maneuvering the first spacecraft from the intermediate position to exit the separation corridor proximate the trailing boundary surface of the separation corridor

21. The apparatus of claim 20, wherein the first spacecraft comprises attitude control thrusters, and the attitude control thrusters are activated to maneuver the first spacecraft proximate a leading boundary surface of the separation corridor.

22. The apparatus of claim 20, wherein the first spacecraft comprises attitude control thrusters, and the attitude control thrusters are activated to maneuver the first spacecraft away from the second spacecraft to exit the separation corridor toward a trailing boundary surface of the separation corridor.

23. The apparatus of claim 20, wherein:
the first spacecraft comprises attitude control thrusters and orbital maneuvering system (OMS) thrusters, and
the means for commanding the first spacecraft to follow the precognitive trajectory comprises:
means for commanding the attitude control thrusters to orient the first spacecraft; and
means for commanding the OMS thrusters to displace the first spacecraft.

24. The apparatus of claim 20, wherein the first spacecraft exits the separation corridor within approximately ¾ of a rotation of the rotating second spacecraft.

25. The apparatus of claim 20, wherein the first spacecraft is maneuvered toward a point on the leading surface of the separation corridor approximately 90 feet from the second spacecraft.
